(19) United States
(12) Patent Application Publication
(10) Pub. No.: US 2006/0280893 A1
(43) Pub. Date: Dec. 14, 2006

(54) Laminating kit and method

(76) Inventor: Gaylon K. Tustison, Cabot, AR (US)

Correspondence Address: J. CHARLES DOUGHERTY, 200 WEST CAPITOL AVE, SUITE 2300, LITTLE ROCK, AR, 72201, US

(21) Appl. No.: 11/449,348

(22) Filed: Jun. 8, 2006

Related U.S. Application Data
(60) Provisional application No. 60/690,381, filed on Jun. 13, 2005.

(51) Int. Cl. B32B 33/00

(52) U.S. Cl. 428/40.1

(57) ABSTRACT

A laminating kit and method for using the kit to perform lamination without a specialized hot-roller lamination machine is disclosed. The kit comprises a resilient board such as foamboard, a folded, release-coated paper to sandwich the lamination project above the resilient board, and an optional liner board attached at the bottom of the resilient board for additional stiffness. Items to be laminated are sandwiched in plastic lamination sheets and inserted between the two ends of the folded, release-coated paper. An iron is then drawn across the kit with its face at an angle to the kit and the bottom edge of the face contacting the kit. Pressure from the iron causes a depression to form in the resilient board, thereby duplicating the effect of heated rollers in a typical commercial lamination machine and resulting in a smooth, bubble-free lamination project.

This application claims the benefit of U.S. provisional patent application Ser. No. 60/690,381, filed on Jun. 13, 2005, and entitled “Laminating Kit and Method.” The complete disclosure of such provisional application is incorporated by reference herein.

### BACKGROUND OF THE INVENTION

The invention is directed to a kit and method of providing lamination to paper sheets and like items, and in particular is directed to a kit and method of providing lamination wherein no specialized lamination machine is required.

The lamination of paper items or other thin materials between clear plastic sheets is well known. The primary reasons for laminating documents and other paper items are to prevent them from begin torn or soiled, and to limit the effects of aging. Lamination provides a means of protecting a document from age-related damage without the expense of providing a controlled atmospheric environment in which the document may be kept. Lamination is thus a practical means to preserve documents that may not be of significant monetary value but may, for example, be desired to be passed through family generations. For this reason, commercially available, heat-activated lamination plastics often include chemicals that protect the lamination material from ultraviolet (UV) damage. Another common purpose for laminating items is to protect them from water damage, particular if such documents are intended to be used in a wet environment, such as maps that are used for boating, hiking, or other outdoor activities. A third common reason for laminating items is to protect documents that are subject to significant wear, such as conversion and sizing charts used in many trades and hobbies, or cards of various types that are intended to be carried on the person. Such cards may include identification or membership cards that often must be removed for verification and replaced in a wallet or purse, thus resulting in significant wear if the card is not protected such as by lamination.

Lamination today is generally performed using a specialized machine designed for this purpose. The most common type of lamination machine includes a set of upper and lower rollers between which the document to be laminated is passed. The document is sandwiched between two sheets of plastic before being introduced to the machine. The machine applies heat to the document/plastic laminate in order to activate the plastic and adhere the protective plastic layer to the document, and to adhere the plastic to itself where the layers touch beyond the edges of the document. Typically the heat is applied to the document by heating the rollers themselves. Such machines are provided by a number of manufacturers, including ACCO Brands of Lincolnshire, Ill.

While specialized lamination machines are easy to operate and provide consistent results, they are generally too expensive for the purchase of a casual or home user who only desires to laminate an occasional item. A home user tempted to try lamination using readily available heat sources, such as a typical clothing iron as might be used for iron-on designs or patches, will likely be disappointed with the results. The steel or rubber rollers used in a lamination machine provide a smooth pressure on the lamination sheets as they are fed linearly through the machine, providing a consistently smooth, bubble-free result. The use of a typical iron and ironing board, on the other hand, will almost certainly result in a laminated product with bubbles between the plastic laminate sheets and the paper or other sheet to be laminated. What is desired then is a kit and method for laminating documents or other like materials that does not require the purchase of an expensive laminating machine in order to produce consistently high-quality, bubble-free lamination results.

### SUMMARY OF THE INVENTION

The invention is a kit and method for the production of high-quality plastic lamination on documents and other like items that does not require a specialized lamination machine but only a simple clothing iron as found in most homes. The kit comprises a resilient board and one or more non-stick surfaces. A home iron or the like may be employed in conjunction with the kit. By drawing the hot iron across the resilient board, with the laminate sheets and product between them, a smoothing effect similar to that produced by the rollers of a lamination machine results. Thus by means of the kit and method a consistently high-quality, bubble-free laminated product may be produced without the need of an expensive lamination machine.

It is therefore an object of the present invention to provide for a kit and method for producing a consistently high-quality, bubble-free laminated product.

It is a further object of the present invention to provide for a kit and method for producing a laminated product without the need of an expensive lamination machine.

It is also an object of the present invention to provide for a kit and method for producing a laminated product using only such additional tools and equipment as are found in the typical home.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a perspective view of a laminating kit according to a preferred embodiment of the present invention.

### DETAILED DESCRIPTION OF THE PREFERRED EMBODIMENTS

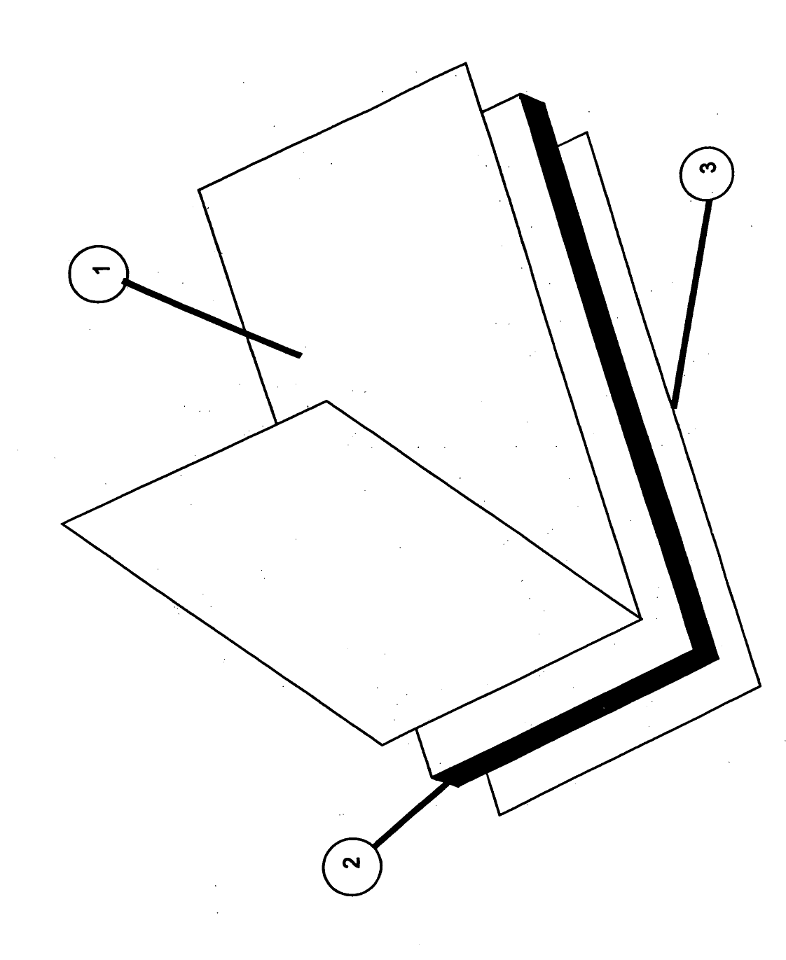

A preferred embodiment of the present invention is illustrated in FIG. 1. The primary components of the laminating kit according to the preferred embodiment are a folded piece of release-coated paper 1; resilient board 2; and liner board 3. In addition, a clothing iron (not shown) of the type commonly found in homes will be employed in the preferred method of practicing the invention, as will be described following.

Release-coated paper 1 is preferably a paper cardstock sheet coated with silicone, as is commonly used for the backing of peel-off labels and like materials. The purpose of the silicone layer is to prevent materials or objects from sticking securely to the paper. The paper itself of release-coated paper 1 may be a traditional pulp-based paper material or may be a plasticized paper, in various embodiments of the invention. While in the preferred embodiment release-coated paper 1 is preferably a single folded sheet, it could also be formed of two separate sheets fitted one on top of the other in an alternative embodiment. The folded sheet is preferred since the kit, when assembled for use, would thus comprise no loose sheets.

Resilient board 2 is preferably formed of an appropriately sized piece of commercial foamboard. Numerous types of foamboard are available on the market today, including, for example, Ultra Mount from United Industries. Such foamboard products comprise a compressible foam core, commonly formed of polystyrene, with a paper or plastic layer on either one or both sides. In alternative embodiments, various substitute materials as are known in the art could be employed as resilient board 2, provided that such material provided a flat surface and an appropriate degree of resilience in response to pressure. Foamboard is the preferred material due to its suitability, low cost, and wide commercial availability. In the preferred embodiment, release-coated paper 1 is permanently adhered to a top surface of resilient board 2, and is preferably sized such that release-coated paper 1 is even with the edges of resilient board 2 on three sides, and the fold of release-coated paper 1 is aligned with the fourth edge of resilient board 2. The release-coated side of release-coated paper 1 should be on the opposite size of release-coated paper 1 from resilient board 2, such that when folded the release-coated surface of release-coated paper 1 comes together and touches. In alternative embodiments, a release coating could be placed on resilient board 2 in place of one side of release-coated paper 1.

Liner board 3 is preferably formed of paper or cardboard. It may also be formed of wood, plastic, or other sufficiently stiff materials, although paper-based materials are preferred due to their low production cost. Liner board 3 is preferably permanently adhered to a bottom surface of resilient board 2, opposite to release-coated paper 1. Liner board 3 is preferably sized such that it is even with the edges of resilient board 2 on all four sides, resulting in a neat appearance. The purpose of liner board 3 is to provide overall stiffness and support to the kit of the preferred embodiment, although in alternative embodiments it may be omitted entirely where sufficient stiffness is provided by the combination of release-coated paper 1 and resilient board 2. Optionally, liner board 3 may be used as a surface for the printing of advertising materials, decorations, or instructions related to the use of the kit of the preferred embodiment.

The kit according to a preferred embodiment of the invention having now been described, the method of utilizing the kit according to a preferred embodiment of the invention may now be set forth, again with reference to FIG. 1. A paper or other sheet that is to be laminated is placed between two sheets of lamination material, typically transparent or translucent plastic lamination sheets. Such materials are available in many different sizes from various manufacturers, such as Avery Dennison Corporation of Brea, Calif. Alternatively, the material to be laminated may be placed in a plastic “pouch” or “sleeve” intended for use in a lamination machine, again which are available from numerous manufacturers such as Avery Dennison. The folded-over, flap or upper portion of release-coated paper 1 is then raised upward by the operator, and the item to be laminated (sandwiched between the plastic laminating sheets or within the pouch or sleeve) is then placed on top of the lower portion of release-coated paper 1, which is attached to resilient board 2. The flap portion of release-coated paper 1 is then folded back down flat over the item to be laminated, and is, preferably, smoothed by hand.

Once the flap portion of release-coated paper 1 is folded down flat, the kit is ready for application of the hot iron. Preferably, the iron is set to the “silk” setting as commonly found on clothing irons intended for home use. Once heated to the appropriate temperature, the iron is placed on top of the folded-over portion of release-coated board 1, with the front of the iron raised slightly. In this position, only the rear edge of the iron will be in contact with the kit, beginning at the end of the kit where the fold in release-coated paper 1 appears. The iron is then slowly drawn across the surface of the kit, proceeding away from the folded end of release-coated paper 1, with pressure being placed on the back edge of the iron's face as it is drawn across the surface. Preferably, a full pass should take about ten seconds for' a laminated item of approximately seven inches in length. Multiple passes may be made for thicker items or when the item to be laminated has a greater width than the iron.

It may be seen that the process of pulling the back edge of the iron's heated surface across the top of release-coated paper 1 causes a corresponding depression to form in underlying resilient board 2. This depression creates a line of high-pressure heat moving across the surface of the item to be laminated, achieving a similar effect to the use of heated rollers as with a traditional laminating machine. The compressibility of resilient board 2 makes this effect possible, and enables the lamination to proceed smoothly without the difficulties that would be encountered if the same process were attempted on a flat, hard surface such as an ironing board. Resilient board 2 also functions as an insulating material, thereby trapping heat at the item to be laminated and allowing the lower plastic lamination sheet to be heated to the appropriate laminating activation temperature without applying undue heat to the top plastic lamination sheet. The result is an effect quite similar to that achieved by heated-roller lamination machines.

Once the ironing pass or passes are complete, the item should preferably be left to cool for approximately thirty seconds before the flap-portion of release-coated paper 1 is raised and the item removed. Preferably, a weighty item, such as a telephone directory or other large book or books, may be placed on top of release-coated paper 1 during the cooling process in order to ensure that the item remains flat once the lamination is complete. Curling may otherwise result as the upper lamination sheet cools slightly faster than the lower sheet adjacent to the insulation of resilient board 2.

The present invention has been described with reference to certain preferred and alternative embodiments that are intended to be exemplary only and not limiting to the full scope of the present invention as set forth in the appended claims.

I claim:

1. A laminating kit, comprising:
(a) a resilient board comprising a top and bottom side; and
(b) a first paper comprising a release-coated side, wherein said first paper is positionable on said top side of said resilient board such that said release-coated side of said first paper faces away from said resilient board; and
(c) a second paper comprising a release-coated side, wherein said second paper is positionable with respect to said first paper such that said release-coated side of said first paper and said release-coated side of said second paper face each other.

2. The kit of claim 1, further comprising a liner board attached at said bottom side of said resilient board.

3. The kit of claim 1, wherein said first and second paper are connected at an edge of said first and second paper.

4. The kit of claim 3, wherein said first and second paper are formed of a single paper sheet folded to form a connected edge of said first and second papers.

5. The kit of claim 1, wherein the release-coated side of said first and second papers comprises a silicone layer.

6. The kit of claim 1, wherein said resilient board comprises foamboard.

7. The kit of claim 5, wherein said top side of said resilient board is integrated with said first paper.

8. A method of laminating an item, comprising the steps of:
(a) enveloping the item to be laminated in a lamination material;
(b) inserting the item between a first and second release-coated paper, wherein a release-coated side of each of the first and second papers are in contact with the lamination material enveloping the item, and wherein the second paper is backed by a resilient board; and
(c) drawing a hot iron across a side of the first paper, wherein a face of the iron is held at an angle that is not parallel to the plane of the first paper such that a rear edge of the face of the iron contacts the first paper and downward pressure from the iron causes a depression in the resilient board.

9. The method of claim 8, further comprising the step of placing a weighted object on top of the first paper until the lamination material enveloping the item cools.

10. The method of claim 8, wherein the first and second papers are connected at an edge, and said step of inserting the item between the first and second papers comprises the steps of folding the papers open at the connected edge such that the first and second papers are held apart, inserting the item between them, and folding the first and second papers closed such that the first paper lies on top of the second paper.

11. The method of claim 10, wherein a release-coated side of each of the first and second papers faces each other when folded.

12. The method of claim 8, wherein said enveloping step comprises the step of placing the item between two lamination sheets.

13. The method of claim 7, wherein said enveloping step comprises the step of inserting the item into a lamination sleeve.
